(19) United States
(12) Patent Application Publication
(10) Pub. No.: US 2014/0129879 A1
(43) Pub. Date: May 8, 2014

(54) SELECTION APPARATUS, METHOD OF SELECTING, AND COMPUTER-READABLE RECORDING MEDIUM

(71) Applicant: FUJITSU LIMITED, Kawasaki-shi (JP)

(72) Inventors: Atsuji SEKIGUCHI, Kawasaki (JP); Toshihiro KODAKA, Yokohama (JP)

(73) Assignee: FUJITSU LIMITED, Kawasaki-shi (JP)

(21) Appl. No.: 14/049,356

(22) Filed: Oct. 9, 2013

(30) Foreign Application Priority Data
Nov. 5, 2012 (JP) 2012-243700

(51) Int. Cl. G06F 11/36

(52) U.S. Cl. CPC G06F 11/3668
USPC 714/38.1

(57) ABSTRACT

A selection apparatus selects advantageous software testing from automated testing and manual testing. The selection apparatus includes an estimator to estimated man-hours for writing and modifying test codes for the automated testing, estimated man-hours for preparing and modifying written procedures for the manual testing, and performing the manual testing, and to select the advantageous software testing based on the comparison of the estimated man-hours for the automated testing with the estimated man-hours for the manual testing, and a presenter to present the advantageous software testing.

### CROSS-REFERENCE TO RELATED APPLICATIONS

This application is based upon and claims the benefit of priority of the prior Japanese Patent Application No. 2012-243700, filed on Nov. 5, 2012, the entire contents of which are incorporated herein by reference.

### FIELD

The present disclosure is directed to a selection apparatus, a method of selecting, and a computer-readable recording medium containing a selection program.

### BACKGROUND

General software has been developed with a scheme that involves release events or deployment of applications and settings in an Information and Communication Technology (ICT) system every year or every several years. Examples of such a scheme include a waterfall methodology.

The waterfall methodology divides a development project into the chronological operational phases including the definition of requirements, external design, internal design, development, testing, and implementation. In principle, the waterfall methodology maintains a phase until the previous phase is completed. Such a scheme minimizes returns to the previous phase.

Conversely, schemes that involve frequent release events have received recent attention. Examples of such a scheme include development using agile software.

Since the agile methodology reduces the quantity of changes in a single release event, it is believed to minimize risks (troubles) caused by such changes and to encourage rapid response to the market.

FIGS. 12A and 12B are diagrams that respectively illustrate an agile methodology and a waterfall methodology, for a comparison purpose.

FIGS. 12A and 12B illustrate correlations between the frequency of changes and the degree of changes of the agile methodology and waterfall methodology, respectively. As described above, the agile methodology, which is illustrated in FIG. 12A, has recently received more attention than the waterfall methodology because the former is effective for the reduction in risk of troubles caused by changes.

The scheme such as a waterfall methodology, which is illustrated in FIG. 12B and involves significant changes barely performed, often employs manual testing. Since the scheme, involving a small number of release events, inevitably needs a small frequency of tests associated with the release events, it finds few benefits to automated testing.

Upon the manual testing, operators follow written procedures preliminarily prepared for the manual testing.

In contrast, the agile methodology of FIG. 12A, which involves frequent release events, employs automated testing.

An increased number of release events in the agile methodology leads to an increased frequency of tests associated therewith; thus, the agile methodology inevitably needs increased man-hours for manual testing. For the reduction in the man-hours for manual testing, the agile methodology employs automated testing using test codes written for the automation of the testing.

The automated testing needs no man-hours for the test. The design and maintenance of the test codes associated with the automation of testing, however, need some additional man-hours. An increased number of release events inevitably leads to an increased frequency of changes in specifications of software.

Thus, even if the scheme which involves frequent release events is employed in the development of software, the man-hours for writing and modifying test codes written for the automation of testing sometimes exceed the man-hours for the preparation of written testing procedures and the manual testing conducted by operators who follow the procedures. The reason for this will now be described as follows.

Likewise a general development process, the design of test codes involves the verification of the testing operations and the debug operations on the test codes. Thus, in a single test, for example, manual testing is often more time-saving than the design of test codes. Since operators can find and correct some errors during the manual testing, the man-hours for performing the manual testing are smaller than those for the design of test codes.

Thus, in a methodology which involves frequent release events, the cost-effectiveness of automated testing is to be compared with that of manual testing in view of the total cost.

Unfortunately, in the conventional scheme, the comparison of the cost-effectiveness of automated testing with that of manual testing is not available at the time of the change in specifications (including addition of specifications).

For example, the scheme which involves frequent release events as illustrated in FIG. 12A, needs the design of test codes for the automation of testing to reduce the man-hours, as described above. Such a scheme may need an increased number of modifications of the test codes associated with the number of changes in the specifications.

In general, testing is conducted by any one of the automated operation and manual operation; thus, only data on any one of the automated operation and manual operation can be obtained. This prevents the comparison of the man-hours for automated testing with those for manual testing.

After several release events with significant changes, such a comparison is impossible even if prior data on both the man-hours for automated testing and those for manual testing is available.

As described above, the conventional methodology can provide reliable data only on the man-hours for automated testing or those for manual testing. Such a situation prevents the selection of automated testing or manual testing based on their time-saving benefits upon the change in specifications.

### SUMMARY

The selection apparatus of the present disclosure selects advantageous software testing from automated testing and manual testing. The selection apparatus includes an estimator to estimate estimated man-hours for writing and modifying test codes for the automated testing, estimated man-hours for preparing and modifying written procedures for the manual testing, and performing the manual testing, and to select the advantageous software testing based on comparison of the estimated man-hours for the automated testing with the estimated man-hours for the manual testing, and a presenter to present the advantageous software testing.

The method of this disclosure is for selecting advantageous software testing from automated testing and manual testing. The method includes estimating estimated man-hours for writing and modifying test codes for the automated testing, estimated man-hours for preparing and modifying written procedures for the manual testing, and performing the manual testing, and selecting the advantageous software testing based on comparison of the estimated man-hours for the automated testing with the estimated man-hours for the manual testing; and presenting the advantageous software testing.

The computer readable recording medium of this disclosure contains a selection program to select advantageous software testing from automated testing and manual testing. Upon being executed by a computer, the selection program allows the computer to estimate estimated man-hours for writing and modifying test codes for the automated testing and man-hours for preparing and modifying written procedures for the manual testing, and to select the advantageous software testing based on comparison of the estimated man-hours for the automated testing with the estimated man-hours for the manual testing and to present the advantageous software testing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating a software developing system according to an embodiment.

FIG. 2 is a schematic diagram illustrating a relation between the data in a specification/test management database according to an embodiment.

FIGS. 3A and 3B illustrate an exemplary relation between a written testing procedure and a test code in the specification/test management database according to an embodiment.

FIG. 4 illustrates an exemplary association between a test case stored in and controlled under the specification/test management database and the other data according to an embodiment.

FIG. 5 illustrates an exemplary management table representing test cases and an exemplary entry table of test process records in the specification/test management database according to an embodiment.

FIG. 6 illustrates an exemplary specification management table representing changes in specification of the specification/test management database according to an embodiment.

FIG. 7 is a flowchart illustrating the processes of a test selection apparatus according to an embodiment.

FIG. 8 is a flowchart illustrating the processes executed by a record processor according to an embodiment.

FIG. 9 is a flowchart illustrating the processes executed by a selecting processor according to an embodiment.

FIG. 10 is a flowchart illustrating the processes executed by an output displaying device according to an embodiment.

FIG. 11 illustrates an exemplary management table representing the test cases in the specification/test management database and an exemplary entry table representing records on test process according to an embodiment.

FIGS. 12A and 12B are diagrams that respectively illustrate an agile methodology and a waterfall methodology, for a comparison purpose.

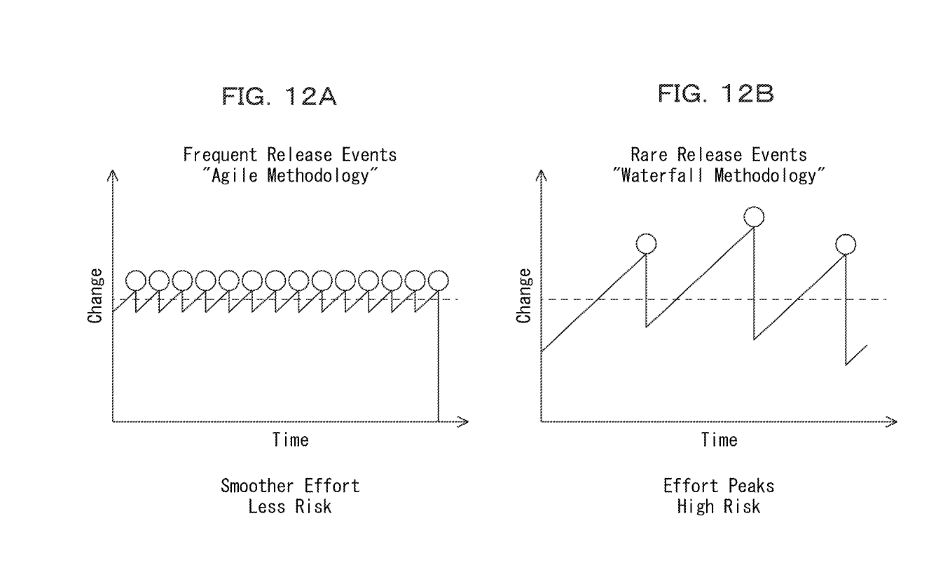

### DESCRIPTION OF EMBODIMENTS

### (A) Embodiments

Embodiments of the present invention will now be described with reference to the accompanying drawings.

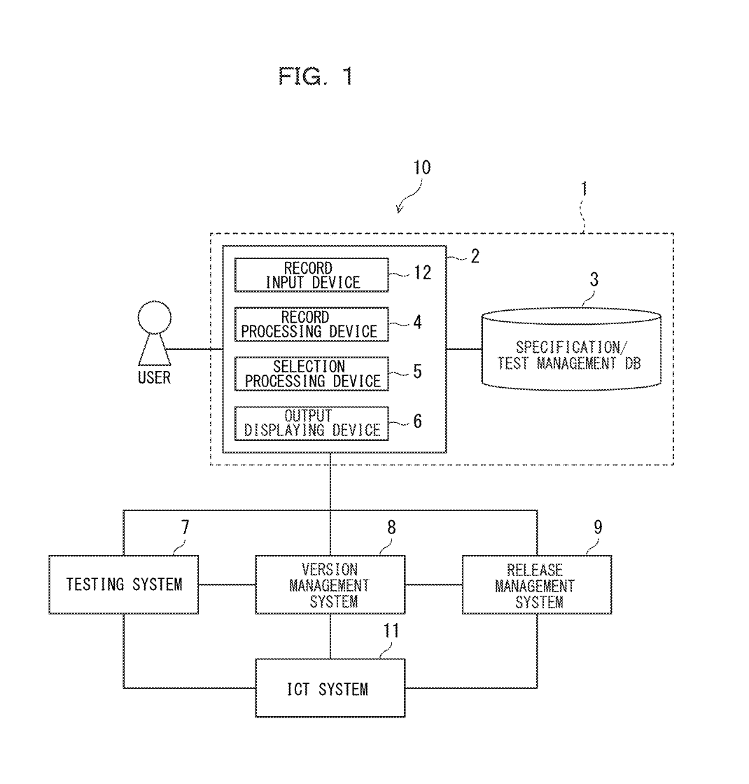

FIG. 1 is a schematic diagram illustrating a software developing system 10 according to an embodiment.

The software developing system 10 includes a test selection system (selection apparatus) 1, a testing system 7, a version management system 8, a release management system 9, and an ICT system 11.

The test selection system 1 estimates the man-hours for the automated test and those for the manual test and selects one of the tests involving less man-hours at the time of the change in the specifications of software. The configuration of the test selection system 1 will be described below.

The testing system 7 executes automated testing for the verification of the operations of the developed software and the related release events using the test codes. The testing system 7 also supports manual testing by a user. Examples of the testing system 7 include JUnit, which is an existing testing system.

The version management system 8 administrates the versions of the software. Examples of the version management system 8 include Subversion®, which is an existing version management system.

The release management system 9 deploys the software and the associated settings developed and verified in their operations by the testing system 7 on the ICT system 11 described below (which are collectively referred to as a release event). Examples of the release management system 9 include Jenkins, which is an existing release management system.

The ICT system 11 is an information processor executing the software and includes a central processing unit (CPU) and a memory (not illustrated). Examples of the ICT system 11 include a server system, which is an existing information processor.

The test selection system 1 includes a selection executing unit 2 and a specification/test management database (DB) 3 containing data sets.

The specification/test management DB 3 contains the data on the specifications and the tests involved in each release event for the software.

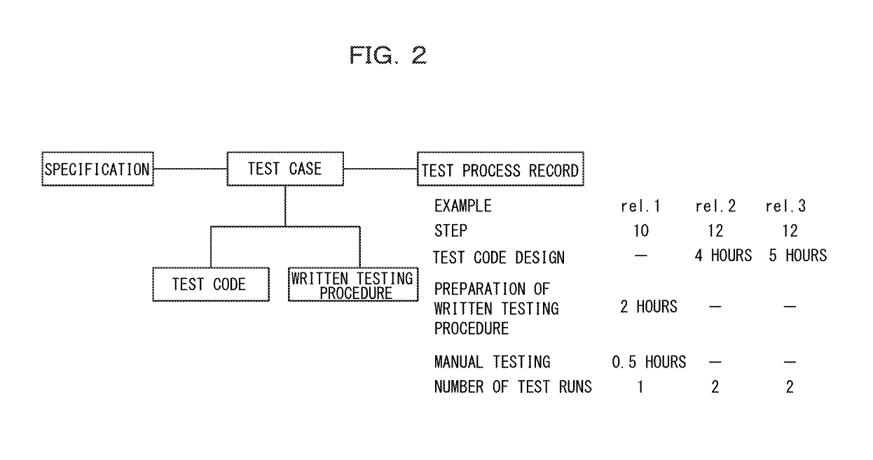

FIG. 2 illustrates an exemplary relation between the data in the specification/test management DB 3 according to an embodiment.

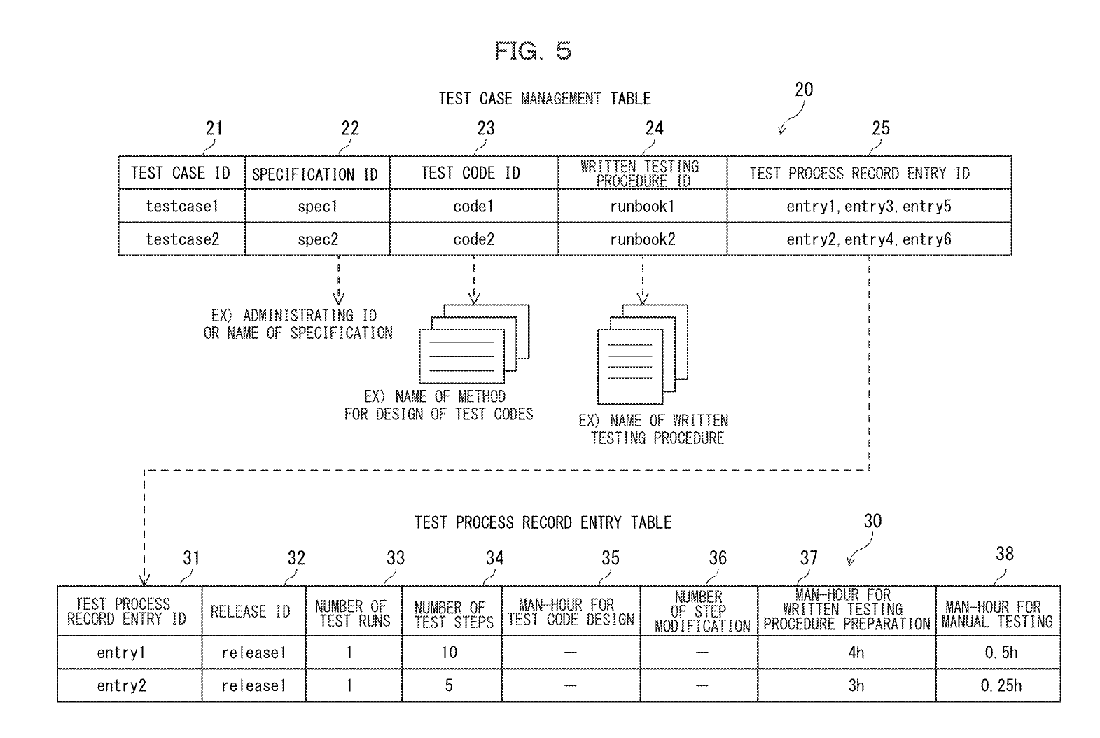

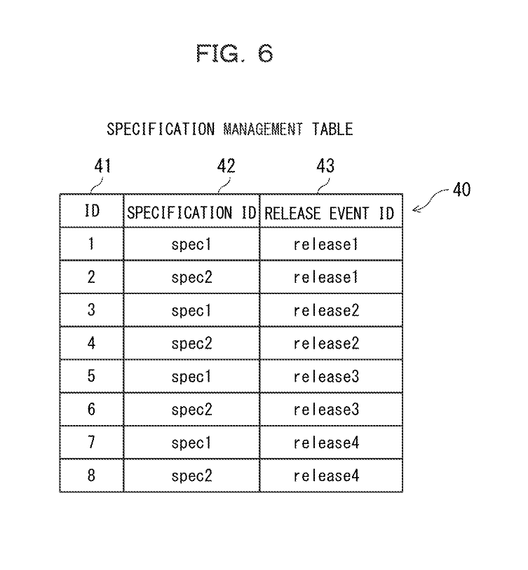

As illustrated in FIG. 2, the specification/test management DB 3 contains the specifications, test cases, and records on the processes of the tests. Specifically, the specification/test management DB 3 includes an management table 20 of the test cases (hereinafter referred to as a test case management table 20), an entry table 30 of the records on the test processes (a test process record entry table 30), and an management table 40 of the changes in specification (a specification management table 40). The details of these tables will be described below with reference to FIGS. 5 and 6.

In general, a software development involves the design of source codes, test codes, or written testing procedures in accordance with the specification.

The specification/test management DB 3 contains the number of test steps, the man-hours for the design and modification of the test codes, the man-hours for the test, and the number of the test runs, every release event or every test case.

The phrase “test case” used herein refers to management information on the written testing procedure associated with the test code.

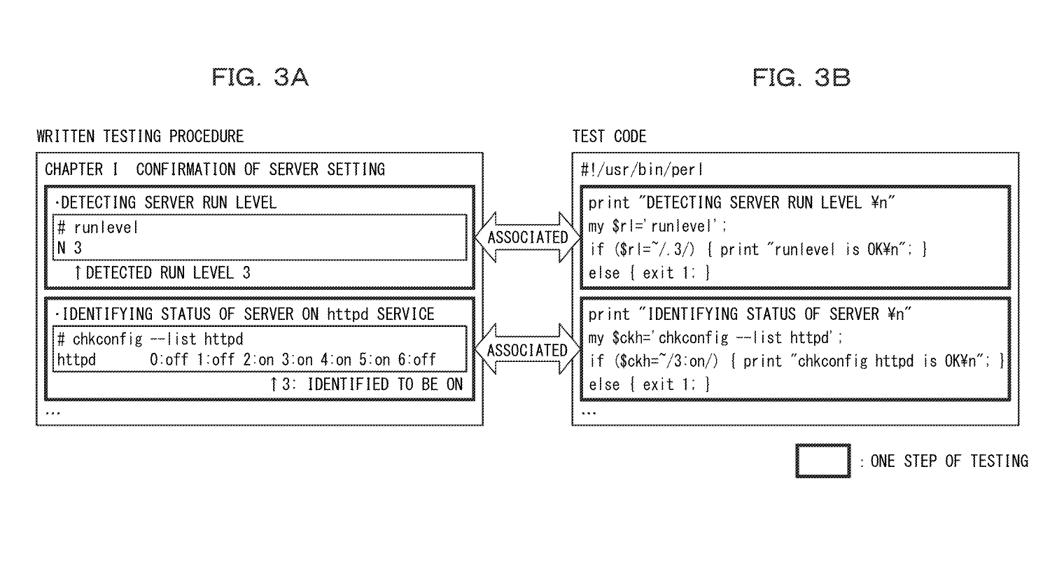

FIGS. 3A and 3B illustrate an exemplary relation between the written testing procedure and the test code in the specification/test management DB 3 according to an embodiment.

The word “test” used herein refers to the verification of the software operation. The test includes at least one step. Examples of the step of the test include login to a server, command execution, and comparison of results.

FIG. 3A illustrates an exemplary written testing procedure for manual testing. FIG. 3B illustrates an exemplary test code for automated testing. The written testing procedure of FIG. 3A and the test code of FIG. 3B each indicate a step of detecting the run level of the server (the upper part enclosed by the heavy line), and a step of identifying the status of the server on httpd service (the lower part enclosed by a heavy line) in the testing. As illustrated in the drawings, the written testing procedure substantially corresponds to the test code.

Thus, the man-hours for the design of test codes for automated testing and the man-hours for the preparation of the written testing procedures for manual testing, and the man-hours for performing the manual testing would be in proportion to the number of the test steps.

Specifically, in general, the test code and the written testing procedure each include steps in sequence, the man-hours for the design and modification of the test codes and the written testing procedures would increase in proportion to the number of the steps.

The written testing procedure and the test code are accordingly associated with each other to be a test case, which is stored in and controlled under the specification/test management DB 3 according to an embodiment.

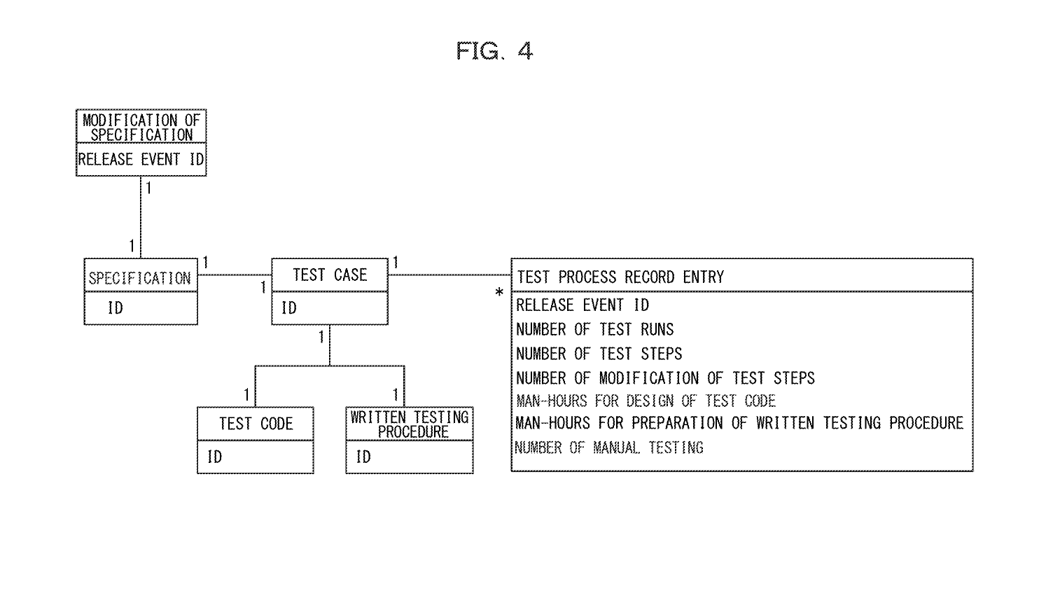

FIG. 4 is an exemplary diagram illustrating an exemplary association between the test case and other data stored in and controlled under the specification/test management DB 3 according to an embodiment. In this embodiment, the association between the data is represented in Unified Modeling Language (UML) by way of example.

FIGS. 5 and 6 illustrate the data stored in the specification/test management DB 3 of FIG. 4 in a form of table.

FIG. 5 illustrates an exemplary test case management table 20 and an exemplary test process record entry table 30 in the specification/test management DB 3 according to an embodiment. FIG. 6 is an exemplary specification management table 40.

The test case management table 20 administrates the test codes, and is generated by a record processing device 4 of a selection executing unit 2 described below with reference to FIG. 1.

The test case management table 20 illustrated in FIG. 5 includes a field 21 containing IDs of the test cases (hereinafter referred to as a test case ID field 21), a field 22 containing IDs of the specifications (a specification ID field 22), a field 23 containing IDs of the test codes (a test code ID field 23), a field 24 containing IDs of the written testing procedures (a written testing procedure ID field 24), and a field 25 containing IDs of the entry records on the test processes (a test process record entry ID field 25).

The test case ID field 21 contains the identifiers specifying the test cases.

The specification ID field 22 contains the identifiers (management IDs or names of the specifications) specifying the specifications subjected to a test. The word “specification” used herein refers to functions of a program, such as a function to verify login with the account name and the password of a user, a function to accept a change in the password within eight characters by a user, and a function to allow a user to add items to a shopping cart.

The test code ID field 23 contains the identifiers specifying the test codes associated with the specifications in the specification ID field 22. For example, the test code ID field 23 contains the names of methods used for a writing of the test codes and the names of shell scripts of the test codes that are associated with the specifications stored in the specification ID field 22.

The written testing procedure ID field 24 contains the identifiers specifying the written testing procedures associated with the specifications stored in the specification ID field 22. For example, the written testing procedure ID field 24 contains the file names of the written testing procedures associated with the specifications stored in the specification ID field 22. If an entry is present in either the test code ID field 23 or the written testing procedure ID field 24, the other fields may be blank (NULL).

The test process record entry ID field 25 lists IDs of the recorded entries of the test processes associated with the test cases in the test case ID field 21. The IDs in the test process record entry ID field 25 correspond to the IDs in the test process record entry ID field 31 of the record entry table 30, which will be described below. The test process record entry ID field 25 can contain a plurality of IDs in a single column. For example, in FIG. 5, the test case management table 20 lists, in the first row, the test case “testcase 1” which is associated with the specification “spec 1”, the script name of the test code “code 1”, the file name of the written testing procedure “runbook 1”, and the recorded entries “entry 1, entry 3, and entry 5”, which correspond to the same IDs in the test process record entry ID field 31 of the test process record entry table 30.

The test process record entry table 30 contains the records on the execution of the test cases. The test process record entry table 30 is generated by a record processing device 4 of a selection executing unit 2, which will be described below with reference to FIG. 1.

The test process record entry table 30, illustrated in FIG. 5, includes a field 31 containing the IDs of the recorded entry of the test process (hereinafter referred to as a test process record entry ID field 31), a field 32 containing the IDs of release events (a release ID field 32), a field 33 containing the number of test runs (a test run number field 33), a field 34 containing the number of test steps (a test step number field 34), a filed 35 containing the man-hours for the design of the test code (a test code design man-hour field 35), a field 36 containing the number of modifications of the steps (a step modification number field 36), a field 37 containing man-hours for the preparation of a written testing procedures (a written testing procedure man-hour field 37), and a field 38 containing the man-hours for performing the manual testing (a manual testing man-hour field 38).

The test process record entry ID field 31 lists the IDs specifying the records on the executions of the test cases. The IDs in the field 31 correspond to the IDs in the test process record entry ID field 25 of the test case management table 20 described above.

The release ID field 32 lists the IDs specifying the release events associated with the executed test cases. For example, the release ID field 32 contains the IDs or the names of the release events.

The test run number field 33 contains the value indicating the total number of the test runs using the test cases for the release event listed in the release ID field 32. Alternatively, the test run number field 33 may contain the number of test runs for the previous release event or may be filled by manual operation of a user.

The test step number field 34 contains the total number of test steps for the release event in the release ID field 32. The number of steps stored in the test step number field 34 is equal to the number of steps of the previous manual/automated testing. The number of the steps may be updated by manual operation of a user after the modification of the test processes.

The test code design man-hour field 35 contains the man-hours for the design or modification of the test code. A valid value (except for NULL, for example) in the step modification number field 36 described below indicates the number of steps that have been modified, while the test code design man-hour field 35 lists man-hours for the modifications of the steps. A value “NULL” in the step modification number field 36 indicates that all of the steps are modified.

The step modification number filed 36 contains the number of steps modified with the test codes.

The written testing procedure man-hour field described above 37 lists the man-hours for the preparation and modifications of the written testing procedures. A valid value in the step modification number field 36 indicates the number of steps that have been modified, while the written testing procedure man-hour field 37 lists the man-hours for the modifications of the steps. A value “NULL” in the step modification number field 36 indicates that all of the steps are modified.

The manual testing man-hour field 38 contains the man-hours for performing the manual testing. Since automated testing needs no man-hours (i.e., Oman-hour) for the testing itself, as described above, no field is provided for storing the man-hours for the automated testing.

The test process record entry table 30 illustrated in FIG. 5, lists, in the first row, “entry1” representing a recorded entry of the release event with the ID “release1”, the total number of the tests executed in the release event “1”, the number of the test steps “10”, the man-hours for writing of the test codes and the number of modifications of the steps in blank, which are not available in the manual testing, the man-hours for the preparation of the written testing procedures “4 h”, and the man-hours for performing the manual testing “0.5 h”.

The specification management table 40 maintains and contains the associations between changes in specifications and release events. The specification management table 40 is generated by a record processing device 4 of a selection executing unit 2 which is described below with reference to FIG. 1.

The phrase “changes in specification” used herein indicates that the program is changed in its function. For example, the function to accept a change in a password within eight characters by a user is replaced with the function to accept a change in a password within 16 characters by a user, and the function to accept a change in a password within eight alphanumeric characters by a user is replaced with the function to accept a change in a password within eight alphanumeric characters and symbols in total.

The specification management table 40 illustrated in FIG. 6 contains an ID field 41, a specification ID field 42, and a release ID field 43.

The ID field 41 contains the identifiers specifying the associations between the changes in the specifications and the release events.

The specification ID field 42 contains the identifiers (management IDs or names of the specifications) indicating the specification subjected to testing.

The release ID field 43 contains IDs of the release events of which specifications related to the specification ID field 42 are changed. The release ID field 43 contains the IDs or names of the release events.

For example, the specification management table 40 in FIG. 6 lists, in the first row, the specification ID “spec 1”, which is changed in the release event with the ID “release1”.

The selection executing unit 2 illustrated in FIG. 1 includes a record input device 12, a record processing device (recorder) 4, a selection processing device (estimator) 5, and an output displaying device (presenter) 6.

The record input device 12 is, for example, an entry device which receives and transmits information input by a user to the record processing device 4. Examples of the record input device 12 include a well-known user interface such as a keyboard, mouse, trackball, and microphone.

The record processing device 4 records the specifications of the tests, the test cases, the test codes, the written testing procedures, and the information for the tests in the test case management table 20, the test process record entry table 30, and the specification management table 40 of the specification/test management DB 3. The information recorded in the record processing device 4 may be based on the information input in the record input device 12 by a user or a history (the average data of the prior testing or the data for the most recent testing).

As described above, since the steps of manual testing is executed in sequence, the man-hours for performing the manual testing by an operator increase in proportion to the number of steps. This embodiment is prepared for a scheme such as an agile methodology, which involves a large number of release events and a small number of modifications of test codes every release event. Since such a scheme does not involve a large number of changes at the same time, the number of steps would be substantially in proportion to the man-hours for the design and modification of the test codes (or the preparing and modifying written testing procedures).

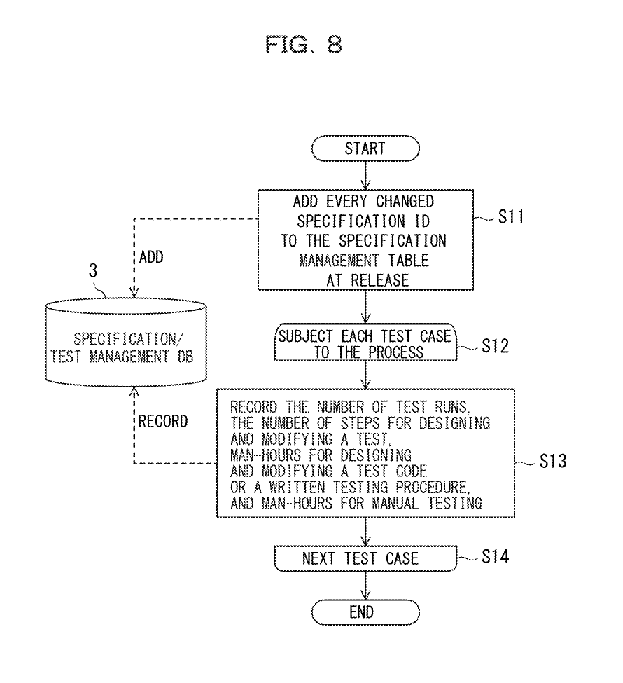

For every test case, the record processing device 4 records the number of steps, the man-hours for the design of test codes, the man-hours for the preparation of the written testing procedures, and the man-hours for the manual test in the specification/test management DB 3, using the a history. Such information can be stored in the record processing device 4 by any means: for example, the man-hours may be recorded using Redmine or through manual entry by a user. Specific recording processes by the record processing device 4 will be described below with reference to FIG. 8.

Note that a “man-hour” used herein is a numerical concept representing workload, and is generally defined with the expression; Man-Hour=Time×Personnel Number. The conventional examples of the unit of a man-hour include “second”, “minute”, “time”, and “day”, which represent a time interval.

The selection processing device 5 estimates the man-hours for the automated testing and the man-hours for performing the manual testing for every test case, based on the data recorded by the recording processing device 4 in the specification/test management DB 3.

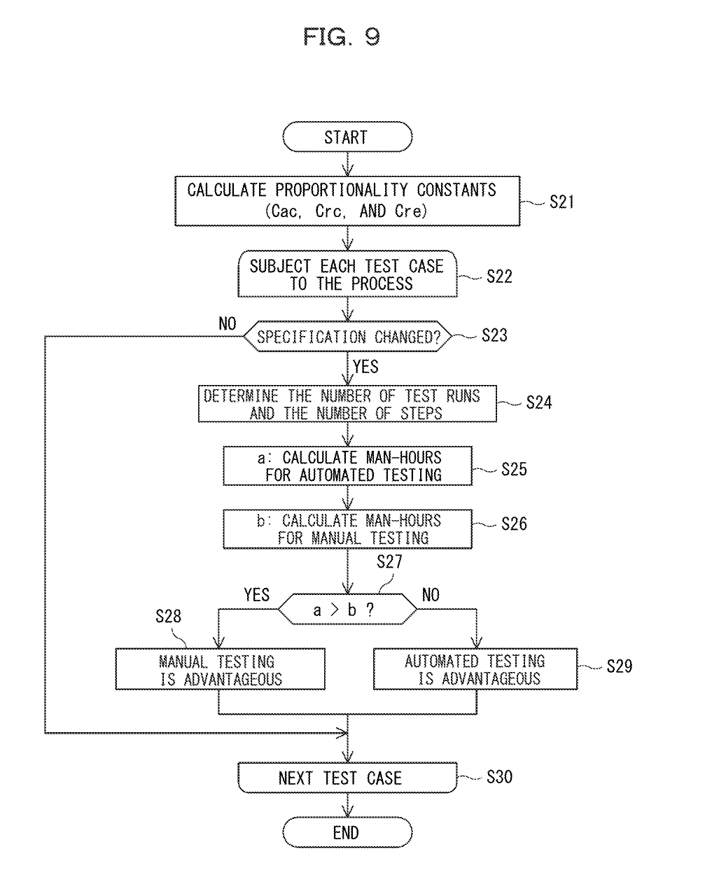

The selection processing device 5 then selects advantageous testing from the automated testing and the manual testing based on the comparison of the estimated man-hours for automated testing with those for manual testing. Specific estimating process by the selection processing device 5 will be described below with reference to FIG. 9.

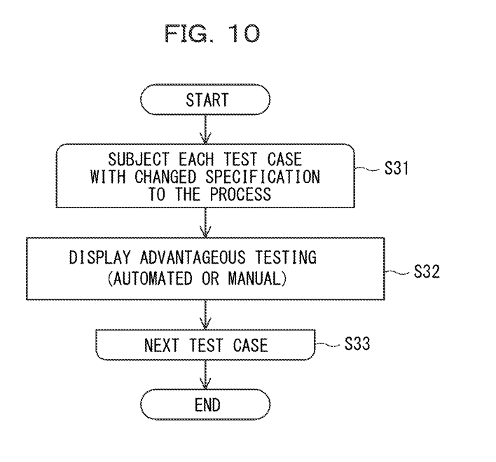

Every estimation of every test case provided by the selection processing device 5 appears on the screen of a personal computer (PC) (not illustrated) of the output displaying device 6. Specific displaying processes by the output displaying device 6 will be described below with reference to FIG. 10.

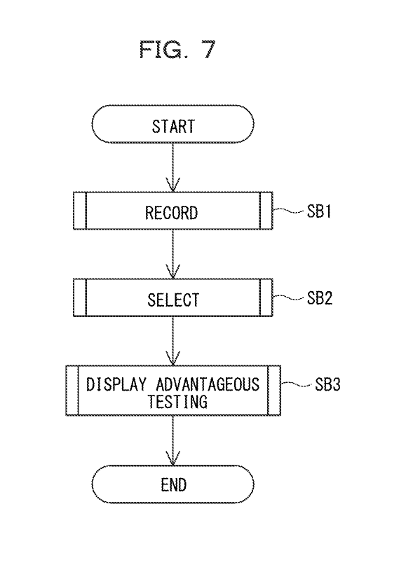

Referring to FIG. 7, the process in the test selection system 1 will now be explained.

FIG. 7 is a flow chart illustrating the process in the test selection system 1 according to one embodiment of the invention.

In step SB1, the record processing device 4 in the test selection system 1 performs recording.

In subsequent step SB2, the selecting processing device 5 in the test selection system 1 performs selection.

In final step SB3, the output displaying device 6 in the test selection system 1 displays advantageous testing by the selection processing device 5.

These steps will now be explained in detail.

The record processing device 4 performs the following process.

FIG. 8 is a flow chart illustrating the process in the record processing device 4 according to one embodiment of the invention.

In step S11, the record input device 12 adds every changed specification ID to the specification management table 40 in response to an input from the user, for example.

In step S12, the record processing device 4 performs the processes up to step S14 for each test case.

In step S13, the record processing device 4 records the number of test runs, the number of steps for designing and modifying a test, the man-hours for designing and modifying a test code or a written testing procedure, and the man-hours for performing the manual testing for each test case obtained in step S12, based on inputs from the user through the record input device 12, for example. The record processing device 4 records these items on the test case management table 20, the test process record entry table 30, and the specification management table 40.

The process then goes to step S14.

Step S14 executes a loop limit procedure to return to step S12. After all the test cases are completely processed, the flow terminates.

The selecting processing device 5 then performs the following process.

FIG. 9 is a flow chart illustrating the process in the selecting processing device 5 according to one embodiment of the invention.

In step S21, the selecting processing device 5 determines the proportionality constant Cac of the man-hours for designing a test code to the number of steps, the proportionality constant Crc of the man-hours for preparing a written testing procedure to the number of steps, and the proportionality constant Cre of the man-hours for performing the manual testing to the number of steps, based on the test process record entry table 30.

The proportionality constant Cac, which is a proportionality constant of the man-hours for designing a test code to the number of steps, is calculated from Equation (1).

Proportionality constant Cac=(the man-hours for designing or modifying a test code)/(the number of steps) Equation (1)

The proportionality constant Crc, which is a proportionality constant of the man-hours for preparing a written testing procedure to the number of steps, is calculated from Equation (2).

Proportionality constant Crc=(the man-hours for preparing or modifying a written testing procedure)/(the number of steps) Equation (2)

The proportionality constant Cre, which is a proportionality constant of the man-hours for performing the manual testing to the number of steps, is calculated from Equation (3).

Proportionality constant Cre=(the man-hours for performing the manual testing)/(the number of steps) Equation (3)

Assuming that the test case is “testcase 1”, the number of steps 10, the man-hours for designing a test code 8 h, the man-hours for preparing a written testing procedure 4 h, and the man-hours for performing the manual testing 0.5 h, the record processing device 4 calculates the proportionality constants Cac, Crc, and Cre according to Equations (1) to (3), respectively, as follows.

Cac=8 h(the man-hours for designing a test code)/10(the number of steps)=0.8 h

Crc=4 h(the man-hours for preparing a written testing procedure)/10(the number of steps)=0.4 h

Cre=0.5 h(the man-hours for performing the manual testing/10(the number of steps)=0.05 h

Thus, the selecting processing device 5 calculates the proportionality constants from the records on only one test case. For the records on multiple test cases, the selecting processing device 5 calculates the proportionality constants for each test case, and determines the averages.

If only the manual testing or automated testing has been performed, the selecting processing device 5 calculates the proportionality constants Cac, Crc, and Cre on the basis of the results of manual testing or automated testing for similar software development registered on the specification/test management DB3.

In step S22, the selecting processing device 5 performs the process up to step S30 for each test case listed in the test case management table 20.

In step S23, the selecting processing device 5 checks for a change in the specifications of the test cases acquired in step S22. The selecting processing device 5 determines that there are changes in the specifications of test cases having valid values (e.g., values except for NULL) in the step modification number field 36 in the test process record entry table 30, for example.

If step S23 detects no changes to specification (see the route “No” in step S23), the process in the selecting processing device 5 goes to step S30 to acquire the next test case in the test case management table 20.

If step S23 detects any change to specification (see the route “YES” in step S23), the selecting processing device 5 acquires the number of test runs, test steps, and step modifications from the test process record entry table 30 in step S24. Specifically, the selecting processing device 5 acquires the values in the field of the number of test runs 33, the test step number field 34, and the step modification number field 36 in the test process record entry table 30.

In step S25, the selecting processing device 5 calculates the man-hours “a” for automated testing. Since the automated testing takes 0 man-hour as described above, the man-hours “a” for automated testing equal the man-hours for designing or modifying a test code. The selecting processing device 5 therefore determines the man-hours “a” for automated testing using Equation (4) on the basis of the proportionality constant Cac obtained in step S21 and the number of steps obtained in step S24.

The man-hours “a” for automated testing=the man-hours for designing or modifying a test code=proportionality constant Cac×the number of steps(the number of test steps or the number of step modifications) Equation (4)

If the value on the number of step modifications in step S24 is not present or is present as an invalid value (such as NULL), no change has been made to the specifications but new specifications have been created; hence, in Equation (4), the number of test steps is used as the number of “steps”. If the number of step modifications in step S24 is present as a valid value, the specifications have been changed; hence, the number of step modifications is used.

In step S26, the selecting processing device 5 calculates the man-hours “b” for manual testing. The man-hours for manual testing equal the sum of the man-hours for preparing or modifying a written testing procedure and the man-hours for performing the manual testing. The selecting processing device 5 therefore determines the man-hours “b” for manual testing using Equation (5) on the basis of the proportionality constants Crc and Cre calculated in step S21 and the number of steps and the number of test runs determined in step S24.

The man-hours for manual testing b=(the man-hours for preparing or modifying a written testing procedure)+(the man-hours for performing the manual testing)×(the number of test runs)=(proportionality constant Crc)×(the number of steps(the number of test steps or the number of step modifications))+(proportionality constant Cre)×(the number of test steps)×(the number of test runs) Equation (5)

If the value on the number of step modifications in step S24 is not present or is present as an invalid value (such as NULL), no change has been made to the specifications but new specifications have been created; hence, in Equation (5), the number of test steps is used as the number of “steps”. If the number of step modifications in step S24 is present as a valid value, a change to the specifications has been made; hence, the number of step modifications is used.

In step S27, the selecting processing device 5 determines whether the man-hours “a” for automated testing calculated in step S25 are greater than the man-hours “b” for manual testing calculated in step S26.

If the man-hours “a” for automated testing are greater than the man-hours “b” for manual testing (see the route “YES” in step S27), the selecting processing device 5 determines the estimated man-hours for the manual testing to be less than those for the automated testing, in step S28.

If the man-hours “a” for automated testing are smaller than the man-hours “b” for manual testing (see the route “NO” in step S27), the selecting processing device 5 determines that the estimated man-hours “a” for automated testing are less than those for the manual testing, in step S29.

The process then proceeds to step S30 and the selection by steps S28 and S29 are written to a selection table (not illustrated).

Step S30 executes a loop limit procedure to return to step S22. After the selecting processing device 5 processes all the test cases, the flow terminates.

The output displaying device 6 performs the following process.

FIG. 10 is a flow chart illustrating the process by the output displaying device 6 according to one embodiment of the invention.

In step S31, the output displaying device 6 performs the process up to step S33 for each test case in the selection table (not illustrated) created by the selecting processing device 5.

In step S32, the output displaying device 6 displays advantageous testing (automated testing or manual testing) for the test cases acquired in step S31.

The process then proceeds to step S33.

Step S33 executes a loop limit procedure to return to step S31. After all the test cases are processed, the flow terminates.

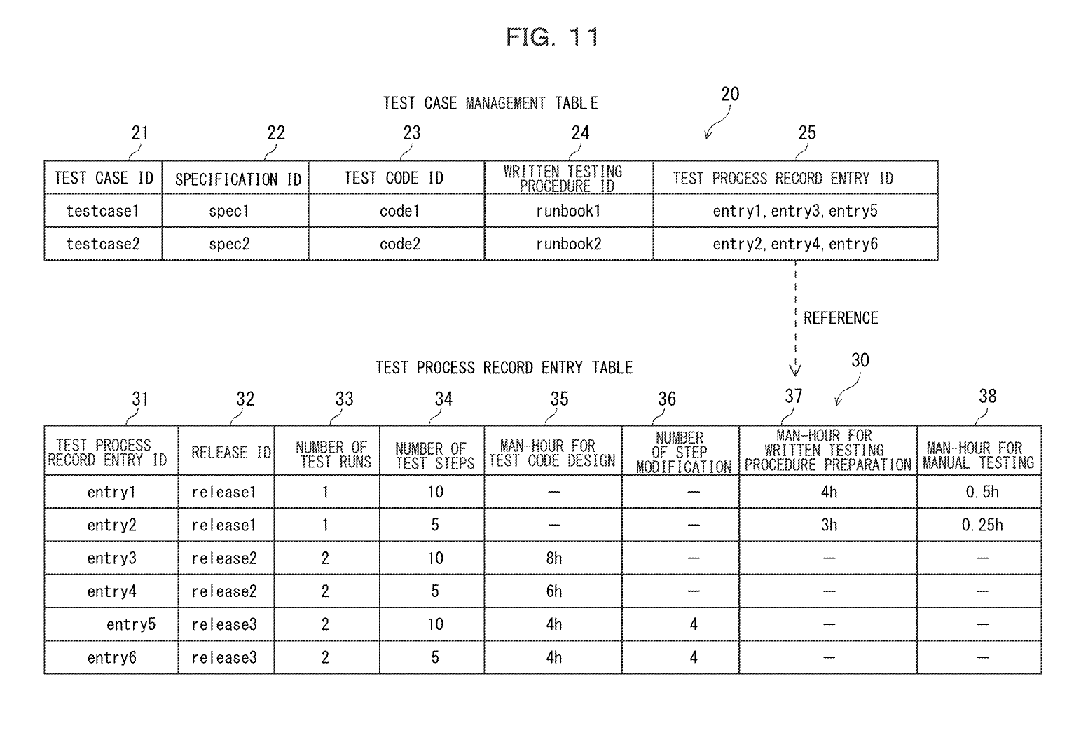

The process of this embodiment will now be explained in detail with reference to FIGS. 6 and 11.

FIG. 11 is an example test case management table and test process record entry table based on specification/test management databases according to one embodiment of the invention.

Now, suppose the following project.

There are two specifications: “spec 1: the user can change the password (within eight characters)” and “spec 2: the user can change the user name (alphanumeric characters within eight characters)”. Here, the current release event is termed “release 4”.

As illustrated in the management table 40 of FIG. 6, these two specifications are changed in “release 4” as well as in the prior releases “release 1”, “release 2”, and “release 3”.

In “release 4”, “spec 1” is changed from “the user can change the password (within eight characters)” to “the user can change the password (within 16 characters)”. In addition, “spec 2” is changed from “the user can change the user name (alphanumeric characters within eight characters)” to “the user can change the user name (alphanumeric characters and symbols within eight characters in total)”.

The relations between the test cases and the specifications are illustrated in the test case management table 20 of FIG. 11.

The test selection by the test selection system 1 under such conditions will now be explained.

The record processor 4 records the test case management table 20 and the test process record entry table 30 in FIG. 11 and the specification management table 40 in FIG. 6 onto the specification/test management DB3, based on inputs from the user through the record input device 12.

Here, in “release 1”, a written testing procedure is prepared to conduct manual testing. Therefore, the first and second rows in the test code design man-hour field 35 of the test process record entry table 30 in FIG. 11 are blank.

In “release 2”, a test code is designed to conduct automated testing. Therefore, the third and fourth rows in the written testing procedure man-hour field 37 and the testing man-hour field 38 of the test process record entry table 30 in FIG. 11 are blank. Since all ten steps for “spec 1” and all the five steps for “spec 2” are changed, the associated rows of the step modification number field 36 are also blank.

In “release 3”, a test code is designed to conduct automated testing. Therefore, the fifth and sixth rows in the written testing procedure man-hour field 37 and the testing man-hour field 38 of the test process record entry table 30 in FIG. 11 are blank. Since only four steps of the ten steps for “spec 1” and four steps of the five steps for “spec 2” are changed, the associated rows in the step modification number field 36 are marked with “4”. As stated above, the values in the test code design man-hour field 35 each represent the man-hours for modifying these four steps.

In step S21 (FIG. 9), the selecting processing device 5 determines the proportionality constants Cac, Crc, and Cre, based on the test process record entry table 30. For each entry, the proportionality constants are determined by the man-hour/the number of steps to average the proportionality constants.

First, the selecting processing device 5 determines the proportionality constant Cac using Equation (1).

The test code design man-hour field 35 contains data for “entry 3” to “entry 6”.

For entries 3 and 4, which represent the man-hours for designing, the selecting processing device 5 employs the value in test step number field 34 as the number of steps (ten for “entry 3” and five for “entry 4”).

For entries 5 and 6, which represent the man-hours for modification, the selecting processing device 5 employs the value in the step modification number field 36 as the number of steps in Equation (1) (four for “entry 5” and four for “entry 6”).

Cac=(8 h/10+6 h/5+4 h/4+4 h/4)/4=1.0

The selecting processing device 5 then determines the proportionality constant Crc for preparing a written test procedure using Equation (2). The written testing procedure man-hour field 37 contains data for entries 1 and 2.

Crc=(4 h/10+3 h/5)/2=0.5

The selecting processing device 5 then determines the proportionality constant Cre for man-hours for performing manual testing using Equation (3).

The testing man-hour field 38 contains data for “entry 1” and “entry 2”.

Cre=(0.5 h/10+0.25 h/5)/2=0.05

In steps S22 and 23 (FIG. 9), the selecting processing device 5 checks for a change in the specification of each test case.

For “testcase 1”, the selecting processing device 5 acquires a specification ID (“spec 1”) associated with this test case from the test case management table 20, and checks for a change in the spec ID in the release event (“release 4”), with reference to the specification management table 40.

If the specification ID (“spec 1”) is registered in the release event (“release 4”) in the management table 40, the process goes to step S24. If not, the selecting processing device 5 checks for a change in the specification ID for the next test case.

Since the test process record entry table 30 in FIG. 11 contains an entry for “testcase 1”, the process in step S23 goes to “Yes”.

In step S24, the selecting processing device 5 determines the number of steps and the number of test runs.

For “entry 5” in the test process record entry table 30, ten, four, and two are respectively derived from the test step number field 34, the step modification number field 36, and the field of number of test runs 33 in former “release 3”.

In step S25, the selecting processing device 5 calculates the man-hours “a” for automated testing using Equation (4). Since prior data is present, the selecting processing device 5 uses the number of step modifications (four) as the number of steps in Equation (4)

(The man-hours for designing or modifying a test code a)=(proportionality constant Cac)×(the number of steps)=Cac×4=1.0×4=4.0

In step S26, the selecting processing device 5 calculates the man-hours “b” for manual testing using Equation (5). Since prior data is present, the selecting processing device 5 uses the number of step modifications (four) as the number of steps in Equation (5). The selecting processing device 5 applies ten to the number of steps for manual testing in Equation (5). (The man-hours for preparing or modifying a written testing procedure)+(the man-hours for performing the manual testing)×(the number of test runs)=(the proportionality constant Crc)×(the number of steps)+(the proportionality constant Cre)×(the number of steps)×(the number of test runs)=Crc×4+Cre×10×2=0.5×4+0.05×10×2=2+1=3.0

In step S27, the selecting processing device 5 determines whether the man-hours “a” for automated testing are greater than the man-hours “b” for manual testing.

From 4.0>3.0, “testcase 1” is determined to be “manual testing” in step S28.

The process goes to “testcase 2”, the selecting processing device 5 derives the corresponding specification ID (“spec 1”) of this test case from the test case management table 20, and determines whether the specification ID is changed in the release event (“release 4”) on the basis of the management table 40.

If the specification ID (“spec 2”) is registered in the release event (“release 4”) in the management table 40, the process goes to step S24. If not, the selecting processing device 5 checks for a change in the specification ID for the next test case.

Since the test process record entry table 30 in FIG. 11 contains an entry for “testcase 2”, the process in step S23 goes to “Yes”.

In step S24, the selecting processing device 5 determines the number of steps and the number of test runs.

For “entry 6” in the test process record entry table 30, five, four, and two are respectively derived from the test step number field 34, the step modification number field 36, and the field of number of test runs 33 in former “release 3”.

In step S25, the selecting processing device 5 calculates the man-hours “a” for automated testing using Equation (4). Since prior data is present, the selecting processing device 5 uses the number of step modifications (four) as the number of steps in Equation (4).

(The man-hours for designing or modifying a test code)=(proportionality constant Cac)×(the number of steps)=Cac×4=1.0×4=4.0

In step S26, the selecting processing device 5 calculates the man-hours “b” for manual testing using Equation (5). Since prior data is present, the selecting processing device 5 uses the number of step modifications (four) as the number of steps in Equation (5). The selecting processing device 5 applies five to the number of steps for manual testing in Equation (5).

(The man-hours for preparing or modifying a written testing procedure)+(the man-hours for performing the manual testing)×(the number of test runs)=(the proportionality constant Crc)×(the number of steps)+(the proportionality constant Cre)×(the number of steps)×(the number of test runs)=Crc×4+Cre×5×2=0.5×4+0.05×5×2=2+0.5=2.5

In step S27, the selecting processing device 5 determines whether the man-hours “a” for automated testing are greater than the man-hours for performing the manual testing b.

From 4.0>2.5, “testcase 2” is determined to be “manual testing” in step S28.

In that case, the number of test runs is two, so that the manual testing has less man-hour than the automated testing for both “testcase 1” and “testcase 2”. If a larger number of test runs (e.g., above eight) is employed, the automated testing would have less man-hour than the manual testing.

Since a test case is not present, the output displaying device 6 displays advantageous testing (“automated” or “manual”) for each test case having a changed specification, in steps S31 to S33 (FIG. 10).

In this case, the following texts are displayed on the screen (not illustrated):

“Testcase 1”: manual testing is recommended.

“Testcase 2”: manual testing is recommended.

This embodiment can determine which testing (automated or manual testing) is recommended for changing the specification.

This enables selection of testing with less man-hour, leading to a cost reduction of testing for software and thus a reduction in the overall cost of the development of the software.

The man-hour estimated based on actual data contributes to accurate selection.

Even with only man-hour data on either automated or manual testing, this embodiment can complete selection on the basis of actual data on the manual testing and automated testing for similar software development.

### (B) Modification

This embodiment can be implemented in any modified mode.

A potential modification is to reflect the frequency of changes in the specification of each test case. Some test cases are subjected to a change in specification every time, and some are barely subjected to a change in specification. In the case of service development, the addition and removal of functions are generally frequent for continuous improvements in service.

In the case of application development, the specification comes to a finished version as the application approaches completion. Finally, almost no change is made to the specification.

Manual testing for a specification that is barely changed may eventually have an increased man-hour. Specifically, almost no change is made to the specification, so that the test case remains unchanged, which results in repeated manual testing and its increased man-hour.

A first modification of the embodiment regarding such a phenomenon is to estimate the man-hours for performing the manual testing that is repeated due to no change in the specification, based on the ratio of the prior changes to specification. This determines which testing (automated or manual testing) would be efficient.

There is a probability theory effective for estimating the man-hours for performing the manual testing that is repeated due to no change in the specification, using, for example, the ratio of the prior changes to specification. The procedure will now be explained.

For one test case, the ratio of stability in the specification equals (the number of times the specification remains unchanged in the management table 40)/(the number of release events).

The estimated probability according to the ratio r of stability in the specification that remains unchanged until the n^{th} release event is expressed as rⁿ, where 0≦r≦1.

Accordingly, the estimated total man-hours for manual testing (the estimated man-hours for manual testing) with a man-hour e (which equals (proportionality constant Cre)×(the number of steps) stated above) repeated due to no change in the specification until the n-th release event is expressed as:

e+er+er²+ . . . +er^{a},

that is,

er(1−rⁿ)/(1−r)(if 0≦r≦1), or

en(if r=1) Equation (6).

In this case, the equation used in the step S26 (FIG. 6) to determine the man-hours “b” for manual testing′ is as follows.

(The man-hours for manual testing b′)=(the man-hours for preparing or modifying a written testing procedure)+(the estimated man-hours for manual testing)×(the number of test runs) Equation (7)

The value in Equation (6) is assigned to “the estimated man-hours for manual testing” in Equation (7).

In step S27, as described above, the selecting processing device 5 compares the man-hours “a” for automated testing with the man-hours “b” for manual testing′.

Note that the variable n may be any value (e.g., three or ∞ selected by the user).

In the case of a test case with a ratio of stability of ⅔, if the man-hours for performing the manual testing are 0.5 h and n is ∞, the value of Equation (7) is as follows:

er/(1−r)(for 0≦r<1), or

∞(for r=1).

If 0.5 is assigned to e, and ⅔ to r, the following value is obtained.

(The estimated man-hours for manual testing)=(0.5)×(⅔)/(1−⅔)=1 h.

The procedure of the first modification will be described later with reference to FIGS. 6 and 11.

In step S24 (FIG. 9), the selecting processing device 5 determines the number of steps and the number of test runs for “testcase 1”.

For “entry 5” in the test process record entry table 30, ten, four, and two are respectively derived from the test step number field 34, the step modification number field 36, and the field of number of test runs 33 in former “release 3”.

In step S25, the selecting processing device 5 calculates the man-hours “a” for automated testing using Equation (4).

(The man-hours for designing or modifying a test code)=(proportionality constant Cac)×(the number of steps)=Cac×4=1.0×4=4.0

In step S26, the selecting processing device 5 calculates the man-hours “b” for manual testing′ using Equation (7).

(The man-hours for manual testing)=(the man-hours for preparing or modifying a written testing procedure)+(the estimated man-hours for manual testing)×(the number of test runs)=(proportionality constant Crc)×(the number of steps)+(the estimated man-hours for manual testing)×(the number of test runs)

The man-hours for manual testing e are expressed as: e=(proportionality constant Cre)×(the number of steps)=0.05×10=0.5 (the estimated man-hours for manual testing)=er/(1−r)=(0.5)×(0.75)/(1−0.75)=1.5 h=Crc×4+1.5×2=0.5×4+3.0=5.0 h

In step S27, the selecting processing device 5 determines whether the man-hours “a” for automated testing are greater than the man-hours “b” for manual testing′.

From 4.0>5.0, “testcase 1” is determined to be “automated testing” in step S29.

If no change to the specification is detected, automated testing is selected as demonstrated above.

The modification produces the same advantages as that of the embodiment and also an additional advantage in that selection can be performed regarding the frequency of changes in the specification.

### (C) Other Modifications

The disclosed technique is not limited to the above embodiment and various changes may be applied to the technique without departing from the scope of the embodiment.

In the embodiment, at the time of a change to specification, the test selection system. 1 estimates the man-hours “a” for automated testing and the man-hours for performing the manual testing to display testing having less man-hour. Alternatively, the test selection system 1 may perform such estimation for development of new software.

In the embodiment described above, the estimation is performed using all a history.

In the estimation using all a history, however, the latest tendency is not sometimes reflected to the calculation of the proportionality constants based on the man-hour and the number of testing steps or to the calculation of the number of test runs.

In view of such a problem, the estimation may use the average of data on the latest n release events (n=an integer number) such that the latest tendency is reflected to the calculation of the proportionality constants.

The embodiment described above determines testing (automated or manual testing) having less man-hour. In addition, the embodiment may select test cases to be subjected to automated testing, according to the user.

Specifically, if the user selects manual testing for one test case, the test case may be eliminated from the list of test cases to be subjected to automated testing. If the user selects automated testing for one test case, the test case may be added to the list of test cases to be subjected to automated testing.

The record processing device 4 and the selecting processing device 5 in the selection executing unit 2 are actuated by executing programs in an internal storage (not illustrated) with a microprocessor in the computer (in this embodiment, a CPU (not illustrated), for example).

Alternatively, they may be actuated by executing programs in a recording medium with the computer.

Programs to actuate the record processing device 4 and the selecting processing device 5 in the selection executing unit 2 are stored in a computer-readable recording medium, such as a flexible disc, CD (including a CD-ROM, CD-R, and CD-RW), DVD (including a DVD-ROM, DVD-RAM, DVD-R, DVD+R, DVD-RW, DVD+RW, and HD DVD), Blu-ray Disc, magnetic disc, optical disc, or magneto-optical disc. The computer reads the programs transmitted from the recording medium to the internal storage or external storage. Alternatively, the computer may read the programs from a storage or recording medium, such as a magnetic disc, optical disc, or magneto-optical disc, via a communication path.

In this embodiment, a computer refers to hardware provided with an operating system, that is, hardware operating under control of an operating system. Alternatively, a computer refers to hardware that is operated only by an application program without an operating system. The hardware includes at least a microprocessor, such as a CPU, and a unit to read computer programs from a recording medium. In this embodiment, a storage unit 3 functions as a computer.

In this embodiment, a computer refers to hardware provided with an operating system, that is, hardware operating under control of an operating system.

The disclosed technique can determine which testing (automated or manual testing) is recommended for changing the specification.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A selection apparatus to select advantageous software testing from automated testing and manual testing, the selection apparatus comprising:
an estimator to estimate estimated man-hours for writing and modifying test codes for the automated testing, estimated man-hours for preparing and modifying written procedures for the manual testing, and performing the manual testing, and to select the advantageous software testing based on comparison of the estimated man-hours for the automated testing with the estimated man-hours for the manual testing; and
a presenter to present the advantageous software testing.

2. The selection apparatus according to claim 1, further comprising a data set used for calculation of estimated the man-hours for the automated testing and the estimated man-hours for the manual testing.

3. The selection apparatus according to claim 2, wherein the data set stores the number of steps of the automated testing, the number of steps of the manual testing, the man-hours for writing of the test codes for the automated testing, the man-hours for preparing the written procedures for the manual testing, and the man-hours for performing the manual testing.

4. The selection apparatus according to claim 3, wherein the estimator calculates a first proportionality constant based on the number of steps of the automated testing, the number of steps of the manual testing, and the man-hours for the design of the test code, a second proportionality constant based on the number of steps of the automated testing, the number of steps of the manual testing, and the man-hours for preparing the written procedures for the manual testing, a third proportionality constant based on the number of steps of the manual testing, and the man-hours for performing the manual testing, and
the estimator calculates the estimated man-hours for the manual testing and the estimated man-hours for the automated testing, based on the first proportionality constant, the second proportionality constant, and the third proportionality constant.

5. The selection apparatus according to claim 3, further comprising a recorder to store the number of steps of the automated testing and the manual testing, the man-hours for writing of the test codes for the automated testing, the man-hours for preparing the written procedures for the manual testing, and the man-hours for performing the manual testing, entered by a user, in the data set.

6. The selection apparatus according to claim 3, further comprising a recorder to record the number of steps of the automated testing and the manual testing, the man-hours for writing of the test codes for the automated testing, the man-hours for preparing the written procedures for the manual testing, and the man-hours for performing the manual testing, in the data set, based on a history.

7. A method for selecting advantageous software testing from automated testing and manual testing, comprising:
estimating estimated man-hours for writing and modifying test codes for the automated testing and estimated man-hours for preparing and modifying written procedures for the manual testing and performing the manual testing, and selecting the advantageous software testing based on comparison of the estimated man-hours for the automated testing with the estimated man-hours for the manual testing; and
presenting the advantageous software testing.

8. The method according to claim 7, further comprising storing the number of steps of the automated testing, the number of steps of the manual testing, the man-hours for writing of the test codes for the automated testing, the man-hours for preparing the written procedures for the manual testing, and the man-hours for performing the manual testing, in a data set.

9. The method according to claim 8, wherein
a first proportionality constant is calculated based on the number of steps of the automated testing, the number of steps of the manual testing, and the man-hours for writing of the test codes,
a second proportionality constant is calculated based on the number of steps of the automated testing, the number of steps of the manual testing, and the man-hours for preparing the written procedures for the manual testing,
a third proportionality constant is calculated based on the number of steps of the manual testing, and the man-hours for performing the manual testing, and
the estimated man-hours for the manual testing and the estimated man-hours for the automated testing are calculated based on the first proportionality constant, the second proportionality constant, and the third proportionality constant.

10. The method according to claim 8, further comprising storing the number of steps of the automated testing, the manual testing, the man-hours for writing of the test codes for the automated testing, the man-hours for preparing the written procedures for the manual testing, and the man-hours for performing the manual testing, entered by a user in the data set.

11. The method according to claim 8, further comprising storing the number of steps of the automated testing, the manual testing, the man-hours for writing of the test codes for the automated testing, the man-hours for preparing the written procedures for the manual testing, and the man-hours for performing the manual testing, in the data set, based on a history.

12. A computer readable recording medium containing a selection program to select advantageous software testing from automated testing and manual testing, wherein the selection program, upon being executed by a computer, allows the computer to estimate estimated man-hours for writing and modifying test codes for the automated testing and estimated man-hours for preparing and modifying written procedures for the manual testing, and to select the advantageous software testing based on comparison of the estimated man-hours for the automated testing with the estimated man-hours for the manual testing and to present the advantageous software testing.

13. The computer readable recording medium according to claim 12, the selection program allowing the computer to store the number of steps of the automated testing, the number of steps of the manual testing, the man-hours for writing the test codes for the automated testing, the man-hours for preparing the written procedures for the manual testing, and the man-hours for performing the manual testing, in a data set.

14. The computer readable recording medium according to claim 13, the selection program allowing the computer to calculate a first proportionality constant based on the number of test steps and the man-hours for test code creation, a second proportionality constant based on the number of test steps and the man-hours for preparing the written procedures for the manual testing, a third proportionality constant based on the number of test steps for the manual testing and the man-hours for performing the manual testing, and
to calculate the estimated man-hours for manual testing and the estimated man-hours for automated testing based on the first proportionality constant, the second proportionality constant, and the third proportionality constant.

15. The computer readable recording medium according to claim 13, the selection program allowing the computer to store the number of steps of the automated testing, the number of steps of the manual testing, the man-hours for writing of the test codes for the automated testing, the man-hours for preparing the written procedures for the manual testing, and the man-hours for performing the manual testing, entered by a user, in the data set.

16. The computer readable recording medium according to claim 13, the selection program allowing the computer to store the number of steps of the automated testing, the number of steps of the manual testing, the man-hours for writing of the test codes for the automated testing, the man-hours for preparing the written procedures for the manual testing, and the man-hours for performing the manual testing, in the data set, based on a history.
